(19) United States
(12) Patent Application Publication
(10) Pub. No.: US 2003/0154147 A1
(43) Pub. Date: Aug. 14, 2003

(54) System and method for web-based job accounting

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/075,222

(22) Filed: Feb. 13, 2002

(51) Int. Cl. G06F 17/60

(52) U.S. Cl. 705/32

(57) ABSTRACT

A remote network based job accounting system and method. The inventive system includes a memory for providing an accounting database; a controller for processing information stored by and retrieved from the database; a network for coupling the machine to the controller; and an interface coupled to the network for providing user input and output. In a specific implementation, the machine is a copy machine equipped with a mechanism for transmitting information to the database via the controller relating to usage of the machine in connection with a predetermined job. In the illustrative embodiment, an authentication database is operationally coupled to the controller. In the best mode, the network is implemented via the Internet. However, the invention is not limited thereto. The inventive system may be implemented in an Intranet environment. In the illustrative embodiment, the user interface is housed within the copy machine. However, the user interface may be implemented separate from the copy machine, i.e., via a land-based or a wireless telephone or a personal computer. The inventive method allows for a user to utilize a print, copy, facsimile, or scanning machine and receive job cost accounting services inexpensively without using dedicated hardware located at the machine.

### BACKGROUND OF THE INVENTION

1. Field of Invention

This invention relates to printers, copiers and other devices. Specifically, the present invention relates to systems and methods for providing accounting for printers, copiers and other devices.

2. Description of the Related Art

For certain applications, it is useful to provide an accounting with respect to printing, copying, and other media production and management operations. For example, many law firms track copies made for clients, in many cases by matter, in order to accurately bill clients for copying services.

Currently, job accounting devices are utilized for this purpose. These devices are typically implemented in hardware manufactured and sold by such companies as Equitrac and Copytrac. These devices typically inhibit copying until pass code, matter code, and/or client code are entered into a keypad. Unfortunately, these devices may be expensive costing $2000 to $5000 each. Inasmuch as a separate device is required for each machine, the solution may be particularly costly for businesses having multiple machines for which accounting is desired. The systems are proprietary and incompatible with those of other vendors and the devices are no value to users that need to make copies while in other facilities or on the road. If printing is to be tracked, the user must also install network software purchased from these vendors at additional cost.

Hence, a need exists in the art for an inexpensive, widely accessible system or method for providing cost accounting for printers, copiers and other such machines, systems and devices. In particular, a system is needed in which the devices themselves can enable job accounting through remote access, verification and reporting.

### SUMMARY OF THE INVENTION

The need in the art is addressed by the remote network based job accounting system and method of the present invention. In accordance with the present teachings, the inventive system includes a memory for providing an accounting database; a controller for processing information stored by and retrieved from the database; a network for coupling the machine to the controller; an embedded web server for communicating with a remote job accounting database; and an interface coupled to the database via network. In accordance with the invention, the interface includes an embedded web server for transmitting and receiving information to and from the database.

In a specific implementation, the machine is a copy machine equipped with a mechanism for transmitting information to the database via the controller relating to usage of the machine in connection with a predetermined job. In the illustrative embodiment, an authentication database is operationally coupled to the controller. In the best mode, the network is implemented via the Internet. However, the invention is not limited thereto. The inventive system may be implemented in an Intranet environment in a peer to peer network.

In the illustrative embodiment, the user interface is housed within the copy machine. However, the user interface may be implemented separate from the copy machine, i.e., via a land-based or a wireless telephone or a personal computer.

In any event, the inventive method allows for a user to utilize a print, copy, facsimile, or scanning machine and receive job cost accounting services inexpensively without using dedicated hardware located at the machine.

### BRIEF DESCRIPTION OF THE DRAWINGS

FIG. 1 is a block diagram showing an illustrative implementation of the system for providing remote job cost accounting for a copy, print, facsimile or scanning machine in accordance with the teachings of the present invention.

FIG. 2 is a block diagram showing an illustrative implementation of a network machine, e.g., copier, implemented in accordance with the teachings of the present invention.

FIG. 3 is a block diagram showing an illustrative implementation of a server in accordance with the teachings of the present invention.

FIG. 4 is a flow diagram showing an illustrative implementation of a method implemented in accordance with the teachings of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

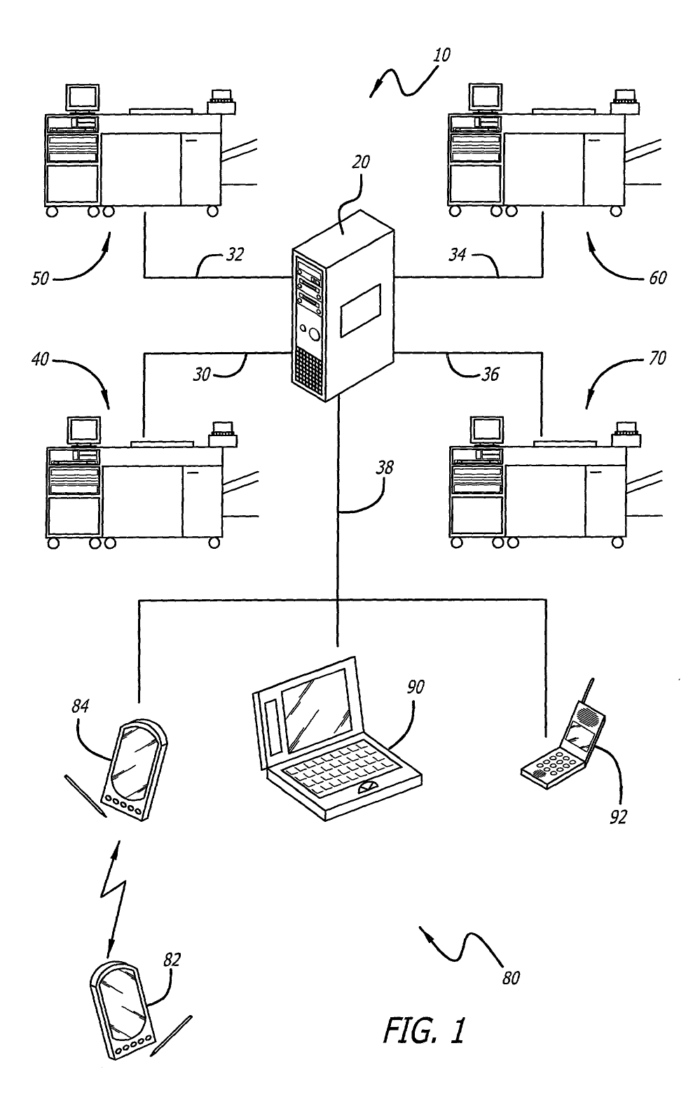

FIG. 1 is a block diagram showing an illustrative implementation of the system for providing remote job cost accounting for a copy, print, facsimile or scanning machine in accordance with the teachings of the present invention. As shown in FIG. 1, the inventive system 10 includes a remote Web server 20 connected via a network 30 to a plurality of machines 40, 50, 60, and 70. In the accordance with the present teachings, each machine is Web enabled through an embedded web server. In the illustrative embodiment, at least one machine 40 is a copy machine. Nonetheless, those of ordinary skill the art will appreciate that the present invention is not limited thereto. That is, the present teachings may be used in connection with print, facsimile, scanning, and other office and industrial machines, vending machines, appliances and other devices and without departing from the scope of the present teachings.

In the best mode, the network 30 is the Internet. Nonetheless, a variety of network topologies e.g., packet-switched, circuit-switched, wireless, etc. may be used without departing from the scope of the present teachings.

In FIG. 1, each network connection is shown with a unique reference numeral e.g., 32, 34, 36, and 38, even though, in most applications, these network connections would typically be of the same network type.

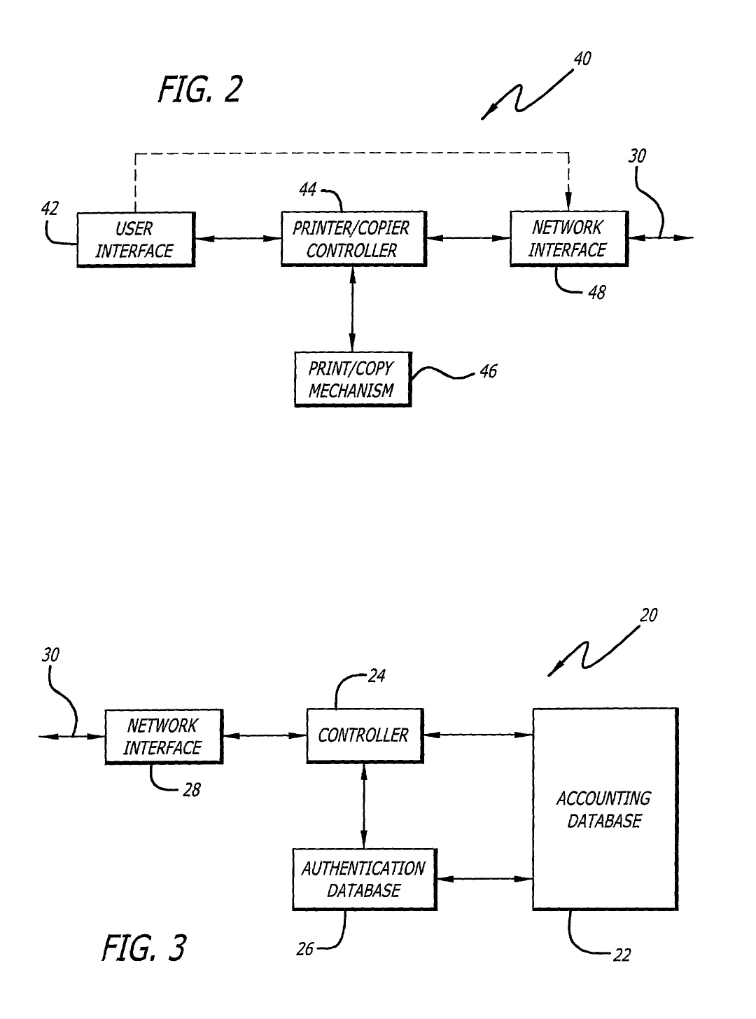

FIG. 2, is a block diagram showing an illustrative implementation of a network machine, e.g., copier, implemented in accordance with the teachings of the present invention. As shown in FIG. 2, the copier 40 includes a user interface 42. In practice, this interface may be provided by the control panel on the copier. However, as illustrated in FIG. 1, numerous other devices may be used to provide the user interface without departing from the scope of the present teachings. For example, the user interface may be implemented via a personal computer connected to the server 20 via a network connection 38. The user interface may be provided by hand held computers 82 and 84 connected wirelessly. Yet another alternative would be to allow for user input via keypad or voice recognition software using a simple telephone 92.

Returning to FIG. 2, the user interface is coupled to a controller 44 adapted to receive commands from the interface 42 and from the server 20 via a network interface 48. The controller 44 controls the operation of the print or copy mechanism 46. As illustrated in FIG. 2, commands from the user interface 42 may bypass the controller 44 and go directly to the server 20 via the network interface 48 and network connection 30. In accordance with the present teachings, the network interface 48 of each machine 40, 50, 60, and 70 is an embedded web server such as a LJ8150, LJ4100, or LJ4550 web server sold by Hewlett Packard.

FIG. 3 is a block diagram showing an illustrative implementation of a server in accordance with the teachings of the present invention. As shown in FIG. 3, the server 20 includes a first memory which provides an accounting database 22 which communicates with a controller 24 and a second memory which provides an authentication database 26. The controller 24 communicates with the network 30 via a network interface 28. Those skilled in the art will appreciate that the network interfaces 28 and 48 would be hardware and software and interfaces appropriate for the network topology utilized.

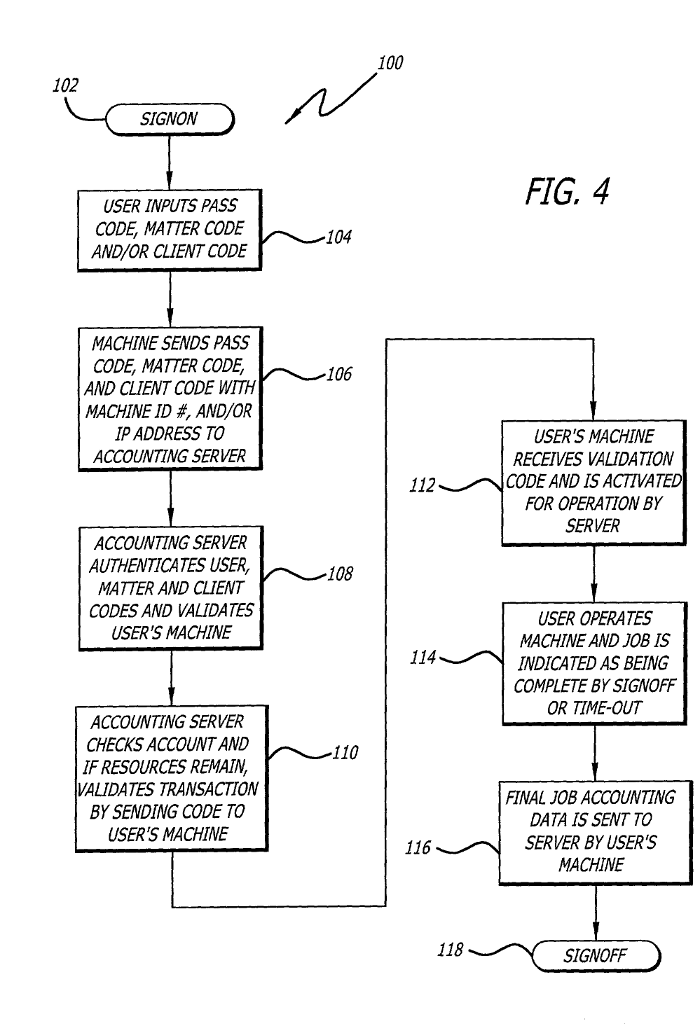

FIG. 4 is a flow diagram showing an illustrative implementation of a method in accordance with the teachings of the present invention. As shown in the diagram 100, at step 102, a machine, e.g. 40, is signed onto the network 30. At step 104, the user inputs pass code, matter code, and/or client code information via the user interface 42 of FIG. 2. At step 106, the machine 40 sends this information along with a machine ID and/or an Internet protocol (IP) address to the server 20. This can be done in multiple fashions such as “posting” this information via the embedded web server to a designated URL. This URL would locate a CGI script that would process and validate or deny the request of user/job authentication. At step 108, the server 20 authenticates the user and checks the matter and client codes against the accounting database 22. At step 110, the server 20 checks the selected account and if, if the account is a resource limited account and sufficient resources remain, validates the transaction by sending the code to the user's machine 40. At step 112, the user's machine receives reactivation code and signals the user that the transaction is authorized via the interface 42. At step 114, the user operates the machine, e.g., makes copies, and when finished, the job is indicated as being complete by virtue of the user signing off or the system timing out. At step 116, final job accounting data, e.g., number of copies made, is sent to the server by the user's machine through the embedded web server 48. At this point, the server makes the appropriate entries in the accounting database 22 reflecting the client and matter to be charged, the user, time, date, and any other information desired by the system designer.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system for remotely providing cost accounting with respect to the usage of a machine, said system comprising:
memory means for providing an accounting database;
controller means for processing information stored by and retrieved from said database;
network means for coupling said machine to said database via said controller; and
interface means coupled to said database via said network for effecting communication therewith, said interface means including an embedded web server for transmitting and receiving said information to and from said database.

2. The invention of claim 1 wherein said machine is a copy machine.

3. The invention of claim 1 wherein said machine is a printing machine.

4. The invention of claim 1 further including means disposed at said machine for transmitting information to said database via said controller relating to usage of said machine in connection with a predetermined job.

5. The invention of claim 1 further including an authentication database operationally coupled to said controller.

6. The invention of claim 1 wherein said user interface is housed within said machine.

7. The invention of claim 1 wherein said user interface is physically separate from said machine.

8. The invention of claim 7 wherein said user interface is a wireless user interface.

9. The invention of claim 1 wherein said network is the Internet.

10. The invention of claim 1 wherein said network is an Intranet.

11. A system for remotely providing cost accounting with respect to the usage of a copy, print or facsimile machine, said system comprising:
an accounting database stored in a memory;
a processor coupled to said memory;
software adapted to run on said processor;
a user interface coupled to said machine;
a network interface coupled to said machine, said network interface including an embedded web server; and
a network coupled between said machine and said processor.

12. A method for remotely providing cost accounting with respect to the usage of a machine, said method including the steps of:
providing an accounting database;
providing user input to said database via a network;
coupling said machine to said network via a web server embedded in said machine; and
storing information with respect to the usage of said machine in said database.
